(19) United States
(12) Patent Application Publication
(10) Pub. No.: US 2011/0179446 A1
(43) Pub. Date: Jul. 21, 2011

(54) SYSTEM AND METHOD FOR COMMUNICATING PROGRAMMING AND ADVERTISING CONTENT THROUGH DIVERSE COMMUNICATION NETWORKS

(76) Inventors: Jeyhan Karaoguz, Irvine, CA (US); Nambirajan Seshadri, Irvine, CA (US); Henry Samueli, Corona Del Mar, CA (US)

(21) Appl. No.: 12/949,049

(22) Filed: Nov. 18, 2010

Related U.S. Application Data
(60) Provisional application No. 61/295,385, filed on Jan. 15, 2010.

(51) Int. Cl. H04N 7/10

(52) U.S. Cl. 725/32

(57) ABSTRACT

A system and method for communicating programming and advertising content through diverse communication networks, substantially as shown in and/or described in connection with at least one of the figures, as set forth more completely in the claims.

### CROSS-REFERENCE TO RELATED APPLICATIONS/INCORPORATION BY REFERENCE

This patent application is related to and claims priority from provisional patent application Ser. No. 61/295,385 filed Jan. 15, 2010, and titled “SYSTEM AND METHOD FOR COMMUNICATING PROGRAMMING AND ADVERTISING CONTENT THROUGH DIVERSE COMMUNICATION NETWORKS,” the contents of which are hereby incorporated herein by reference in their entirety. This patent application is also related to U.S. patent application Ser. No. ______, filed concurrently herewith, titled “SYSTEM AND METHOD IN A PROGRAM RECORDER FOR MANAGING ADVERTISEMENT PRESENTATION”, Attorney Docket No. 21194US02; U.S. patent application Ser. No. ______, filed concurrently herewith, titled “SYSTEM AND METHOD FOR UPDATING ADVERTISING CONTENT FOR A RECORDED PROGRAM”, Attorney Docket No. 21195US02; U.S. patent application Ser. No. ______, filed concurrently herewith, titled “SYSTEM AND METHOD FOR PROVIDING USER SPECIFICATION OF ADVERTISING CONTENT”, Attorney Docket No. 21196US02; U.S. patent application Ser. No. ______, filed concurrently herewith, titled “SYSTEM AND METHOD FOR MONITORING AND REPORTING PRESENTATION OF RECORDED ADVERTISING CONTENT”, Attorney Docket No. 21197US02; and U.S. patent application Ser. No. ______, filed concurrently herewith, titled “SYSTEM AND METHOD FOR PROVIDING VIEWER IDENTIFICATION-BASED ADVERTISING”, Attorney Docket No. 21198US02. The contents of each of the above-mentioned applications are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Advertising media is typically provided with programming media (e.g., embedded in programming media transmitted by a programming provider). Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for communicating programming and advertising content through diverse communication networks, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 shows a non-limiting exemplary flow diagram of a method for communicating programming and advertising content, in accordance with various aspects of the present invention.

FIG. 2 shows a non-limiting exemplary flow diagram of a method for communicating programming and advertising content, in accordance with various aspects of the present invention.

FIG. 3 is a diagram illustrating an exemplary media content distribution environment.

FIG. 4 is a diagram illustrating various non-limiting aspects of exemplary user equipment, in accordance with various aspects of the present invention.

FIG. 5 is a diagram illustrating exemplary modules and/or sub-modules for user equipment, in accordance with various aspects of the present invention

### DETAILED DESCRIPTION OF VARIOUS ASPECTS OF THE INVENTION

The following discussion will refer to various communication modules, components or circuits. Such modules, components or circuits may generally comprise hardware and/or a combination of hardware and software (e.g., including firmware). Such modules may also, for example, comprise a computer readable medium (e.g., a non-transitory medium) comprising instructions (e.g., software instructions) that, when executed by a processor, cause the processor to perform various functional aspects of the present invention. Accordingly, the scope of various aspects of the present invention should not be limited by characteristics of particular hardware and/or software implementations of a module, component or circuit unless explicitly claimed as such. For example and without limitation, various aspects of the present invention may be implemented by one or more processors (e.g., a microprocessor, digital signal processor, baseband processor, microcontroller, etc.) executing software instructions (e.g., stored in volatile and/or non-volatile memory). Also for example, various aspects of the present invention may be implemented by an application-specific integrated circuit (“ASIC”) and/or other hardware components.

Additionally, the following discussion will refer to various system modules (e.g., user equipment modules). It should be noted that the following discussion of such various modules is segmented into such modules for the sake of illustrative clarity. However, in actual implementation, the boundaries between various modules may be blurred. For example, any or all of the functional modules discussed herein may share various hardware and/or software components. For example, any or all of the functional modules discussed herein may be implemented wholly or in-part by a shared processor executing software instructions. Additionally, various software sub-modules that may be executed by one or more processors may be shared between various software modules. Accordingly, the scope of various aspects of the present invention should not be limited by arbitrary boundaries between various hardware and/or software components, unless explicitly claimed.

The following discussion may also refer to communication networks and various aspects thereof. For the following discussion, a communication network is generally the communication infrastructure through which a communication device (e.g., a set top box, a video recorder, a personal video recorder, an electronic device with video recording and/or presentation capability, a television receiver, a television, a television controller, a portable communication device, a video content provider, a television program provider, an advertising video provider, a data network communication service provider, a radio, a personal media player, etc.) may communicate with other systems. For example and without limitation, a communication network may comprise a cable and/or satellite television communication network, a cellular communication network, a telecommunication network, a general data communication network (e.g., the Internet), a wireless metropolitan area network (WMAN), a wireless local area network (WLAN), a wireless personal area network (WPAN), any home or premises communication network, a wireless broadcast radio network, etc. A particular communication network may, for example, generally have a corresponding communication protocol according to which a device (e.g., user equipment comprising an electronic device with media presentation capability) may communicate with the communication network. Unless so claimed, the scope of various aspects of the present invention should not be limited by characteristics of a particular type of communication network and/or communication protocol.

Additionally, the following discussion will at times refer to media content, where video content and audio content are non-limiting examples of media content. Such media content may, for example, comprise various types of television (or radio) programming (e.g., television programs, news programs, sports programs, music television, movies, television series programs, educational programs, live or recorded television programming, broadcast/multicast/unicast television programming, etc.). Such media content may, for example, comprise real-time television (or radio) broadcast programming (or multicast or unicast television programming) and/or user-stored television programming that is stored in user equipment (e.g., a VCR, PVR, etc.). Such media content may also, for example, comprise advertising media content (e.g., a video commercial, an audio commercial, a still image advertisement, a user-interactive advertisement, advertising content embedded in and/or separate from television programming, etc.). Such media content may also, for example, comprise graphical and/or textual content that may be displayed on a television screen (e.g., an electronic program guide, user interface menu, a television set-up menu, a typical web page, a document, a graphical video game, etc.).

Advertising media is typically provided with programming media (e.g., embedded in programming media transmitted by a programming provider), where such programming media is communicated over a single programming network. Such communication of advertising and programming content is generally inflexible. For example, advertising content is generally presented to a large audience when only a small portion of the audience is interested in such advertising content. To address such inflexibility, advertising content may be directed to particular users and/or user groups. Present programming networks, however, might not provide the flexibility and/or available bandwidth to provide for such flexible advertising.

As a non-limiting example, user television equipment (e.g., a set top box, a PVR, etc.) may comprise cable and/or satellite data modem capability. Such a modem may, for example, be utilized to receive electronic program guide information, set top box configuration information, secure access information, etc. In such a configuration, such user television equipment is capable of communicating substantial amounts of data (e.g., video data) via a general data network (e.g., the Internet) and communicating programming content via the cable television network television channels. Various aspects of the present invention may leverage such capability to provide for the flexible communication of programming and advertising content via different respective communication networks. The following figures, and discussion thereof, will provide various non-limiting examples of such operation.

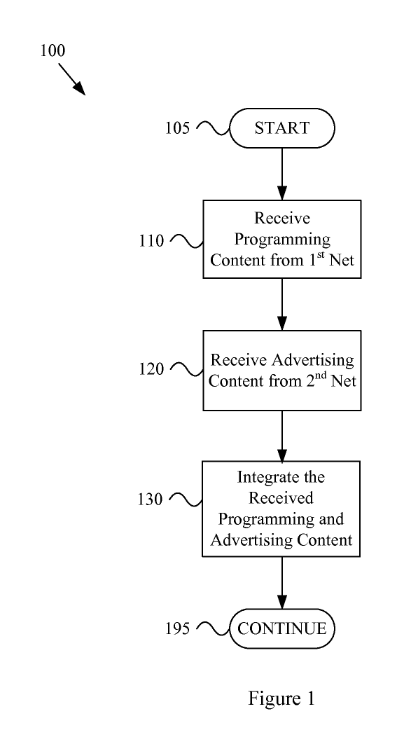

FIG. 1 shows a non-limiting exemplary flow diagram of a method 100 for communicating programming and advertising content, in accordance with various aspects of the present invention. Any or all aspects of the exemplary method 100 may, for example, be implemented in user equipment (e.g., a user media presentation system, a personal video recorder, a television receiver (or set top box) with or without video recording capability, a gaming device, a personal computing device (e.g., handheld, notebook, laptop, desktop, etc.), etc.).

The exemplary method 100 may begin executing at step 105. The method 100 may begin executing in response to any of a variety of causes and/or conditions, non-limiting examples of which will now be provided. For example, the exemplary method 100 may begin executing in response to utilization of user media equipment to present programming (e.g., television programming, radio programming, etc.). Also for example, the exemplary method 100 may begin executing in response to an explicit user command to begin such operation. Further for example, the exemplary method 100 may begin executing in response to determining that an advertising profile exists for the user and/or group of users determined to be utilizing the user equipment to present media content. Additionally for example, the exemplary method 100 may begin executing in response to a detected event or system condition.

The exemplary method 100 may, for example at step 110, comprise receiving programming content from a first communication network (or a first one-or-more communication networks). Step 110 may comprise receiving programming content in any of a variety of manners, non-limiting examples of which will now be provided.

For example, step 110 may comprise receiving television programming (e.g., a television program) from a television network (e.g., a cable and/or satellite communication network, a legacy over-the-air television network, a data network with television content capability, an Internet television network, etc.). For example, step 110 may comprise receiving television programming via a single television network, or may comprise receiving television programming via a plurality of different television networks. Also for example, step 110 may comprise receiving television programming via a local or personal area network.

Step 110 may also, for example, comprise receiving audio programming (e.g., an audio program) from a radio network (e.g., a satellite radio network, an Internet radio network, a legacy over-the-air radio network, a cable television music channel, etc.). For example, step 110 may comprise receiving audio programming via a single television network, or may comprise receiving audio programming via a plurality of different audio networks. Also for example, step 110 may comprise receiving audio programming via a local or personal area network.

Step 110 may also comprise receiving information regarding advertising content (e.g., regarding advertising content that is to be presented with the received programming). For example, such information regarding advertising content may be received embedded in received media programming (e.g., in a data stream and/or file header or metadata, at a location in a programming data stream or file at which advertising content is to be inserted, at a location in a programming data stream or file that is prior to a commercial break (e.g., such that corresponding advertising content may be retrieved in time for utilization in an upcoming commercial break in such programming), etc.).

Also for example, such information regarding advertising content may be received with program guide information. For example, such information regarding advertising content may be received in a data stream that communicates channel, time and date information for television programs. For example, information for a particular television program may comprise information regarding advertising content that corresponds to the particular television program (e.g., regarding advertising content that is to be presented during presentation of the particular television program).

Further for example, such information regarding advertising content may be received in a data stream (or data file) independent of television programming information and electronic program guide information. For example, such information regarding advertising content may be received during periodic advertising update communications, during user account information communication, etc.

Note that step 110 may comprise receiving such information regarding advertising content for programming from any of a variety of communication networks. For example, step 110 may comprise receiving such information from the same communication network(s) over which media programming content is received. For example, step 110 may comprise receiving such information and receiving television programming content via a same television network. Also for example, step 110 may comprise receiving such information from one or more communication networks different from the communication network(s) over which media programming content is received. For example, step 110 may comprise receiving such information over a general data network or telecommunication network and receiving media programming content via a television network.

Such information regarding advertising content may comprise any of a variety of characteristics, non-limiting examples of which will now be provided. For example, the information regarding advertising content may, for example, comprise information describing the relationship between programming content and advertising content (e.g., information describing the overall presentation of media content comprising both programming content and advertising content). Such relationship may, for example, comprise information describing a temporal relationship between programming content and advertising content. For example, such information may comprise information identifying a time in programming content at which advertising content should start, a time window in programming content during which advertising content should be inserted and presented, etc. Such time information may, for example, comprise information regarding required exact timing and/or recommended (or target) timing.

Such timing information may, for example, comprise a plurality of timing options. Such timing options may, for example, be selected based on whether and/or how much advertising is to be presented. For example, different respective users and/or user equipment may correspond to different respective amounts of advertising to be presented. For example, different users may pay for different respective levels of service, where such different levels of service may correspond to different respective amounts of advertising content. Some of such levels of service may, for example, correspond to the presentation of no advertising content. Also for example, a timing option may be selected based on the availability of advertising. For example, in a scenario in which advertising content that is ideally to be presented during a particular time window is unavailable, a shorter-than-normal time window may be selected from the plurality of timing options, and a longer-than-normal time window may be selected for a subsequent advertising content time window to compensate for the currently selected short-than-normal time window.

Such timing information may, for example, comprise information identifying timing constraints on an advertising window that may be flexibly filled by the system (or user equipment) implementing the method 100. For example, in an exemplary scenario, such timing information might indicate that at time A+/−2 minutes, the system will stop presentation of a media program and present B minutes+/−15 seconds of advertising before resuming presentation of the media program. Such flexibility may, for example, be utilized advantageously in systems providing targeted advertising of a wide variety of different respective advertising content to different respective users. Note that such operation may also comprise buffering programming content to compensate when inserted advertising content is larger than an allocated time window, and playing buffered programming content to fill-in when inserted advertising content is smaller than an allocated time window.

The information regarding advertising content may also, for example, comprise information identifying particular advertising content. For example, such information may comprise information of a title of an advertisement (or title of an advertising content data file). Also for example, such information may comprise information of a version number (or date) for an advertisement. In such a scenario, user equipment, which may have advertising content stored on-board or on a local networked storage device, may determine whether such locally stored advertising content should be updated. Additionally for example, such information may comprise information of a memory system path to a stored advertising content file (e.g., listing disc drive, file directory structure, and file name). In an exemplary scenario, the information regarding advertising content may be inserted in a media program such that when such information is encountered, such encounter will trigger retrieval, receiving, and insertion of the specifically-identified advertising content.

The information regarding advertising content may, for example, comprise information identifying one or more sources for identified advertising content. Such source information may, for example, comprise information identifying a particular advertiser, a communication network source, a centralized advertising content database, a content provider's server, etc.

In an exemplary scenario, such source information may comprise information identifying a communication network address of the source of the advertising content. Such a communication network address may, for example, comprise a Uniform Resource Locator (URL) associated with advertising content. Such a communication network address may, for example, comprise an Internet address, local area network address, personal area network address, telecommunication network address, television network address, etc. Such source information may, for example, comprise information of a communication network address and a directly path for a file at such address.

Such source information may, for example comprise information identifying a programming source, an advertising agency, a commercial enterprise associated with a particular advertised good and/or service, etc. As mentioned above, such source information may comprise information identifying one or more communication network addresses associated with such entities (or with networked equipment associated with such entities).

In an exemplary scenario, such source information may identify a plurality of different communication network addresses associated with a plurality of different respective advertisements, where such network addresses may be on a same network (e.g., a programming network, the Internet, etc.) or such network addresses may be on different respective networks (e.g., a first network address for advertising content on a programming network, a second network address for advertising content on the Internet, a third network address for advertising content on a telecommunication network, a fourth network address for an advertisement on a local area network, etc.).

Advertising content may, for example, be consistent between all presentations of a program, or such content may be targeted to particular users and/or households. For example, information regarding advertising content may comprise a list of advertisements that must be presented, should be presented, and/or may be presented during a program. Such a list may, for example, be universal or customized for a user, a group of users, a home media presentation system (or other user equipment), a household, etc.

Also for example, such information regarding advertising content may comprise information identifying alternative advertising content that may be presented during presentation of a program. For example, in such a scenario, the user equipment (or other equipment implementing the method 100) may select from between a plurality of advertising content options for presentation during programming content presentation.

In general, step 110 may comprise receiving programming content from a first communication network. Accordingly, the scope of various aspects of the present invention should not be limited by characteristics of any particular manner of receiving programming content and/or by characteristics of receiving information in addition to programming content (e.g., information regarding advertising content) unless explicitly claimed.

The exemplary method 100 may, for example at step 120, comprise receiving advertising content from a second communication network (or a second one-or-more communication networks) different from the first communication network. Step 120 may comprise receiving advertising content in any of a variety of manners, non-limiting examples of which will now be provided.

As discussed above, advertising content may be identified as being provided over various networks, which may or may not be the same as the network(s) over which programming content is provided. For example, step 120 may comprise receiving the advertising content from a second communication network that is different from the first communication network via which programming content is received (e.g., at step 110), and may also comprise receiving advertising content from the first communication network. In such a scenario, advertising content that is ultimately presented to the user may be received from a plurality of different communication networks. Note that such different communication networks may share common components (e.g., a portion of cable television infrastructure may carry both television network programming traffic and Internet data traffic). Alternatively for example, such different communication networks may be completely independent of each other. Note that even in an exemplary scenario in which advertising content is received over a communication network different from the communication network via which programming content is received at step 110, such advertising content and programming content may be received from a same source or from different respective sources.

Step 120 may, for example, comprise receiving advertising content in a passive and/or active manner. For example, step 120 may comprise passively receiving advertising content that is broadcast and/or advertising content that is addressed to equipment (e.g., user equipment) implementing the method 100 (e.g., unicast advertising content, multicast advertising content, etc.). Such advertising content may, for example, be received without requesting such content.

Also for example, step 120 may comprise actively retrieving advertising content (e.g., by request or solicitation) from a source of such content. As discussed above, information regarding advertising content may be received, where such information identifies advertising content and/or a source of such advertising content. In such an exemplary scenario, step 120 comprise communicating a message to such an advertising content source to request the identified advertising content from such source, and then receiving the requested advertising content from such source.

In a non-limiting exemplary scenario, programming content and programming guide information may be received from a cable television network. As discussed above, such programming guide information may identify the source of a program, advertising content to be presented during such a program, and sources of such advertising content. Before or during presentation of a selected program, the step 120 may comprise retrieving the identified advertising content associated with a selected program. For example, during presentation of a movie, step 120 may comprise concurrently communicating with an advertising agency or advertiser over the Internet, while step 110 is receiving programming content, to obtain advertising content for presentation during the program being received at step 110 (e.g., at the next commercial break). That is, the programming content receiving and the advertising content receiving may be performed concurrently (e.g., simultaneously and/or pseudo-simultaneously in a time-multiplexed manner). In such an exemplary scenario, at a designated point in the program (e.g., as flagged by the programmer), the retrieved advertising content may be presented.

In another exemplary scenario, information identifying advertising content may be received with the programming content received at step 110 (e.g., embedded in the program video/audio data, included in a file or data stream header, included as metadata, etc.). Step 120 may then retrieve/receive the identified advertising content.

In yet another exemplary scenario, a receiver may receive and play a television program. During presentation of the television program, the receiver (e.g., at step 110 and/or step 120) identifies advertising content, advertising content presentation timing, and the source of such advertising content. Then, during presentation of the television program, the receiver (e.g., at step 120) retrieves the advertising content over one or more various networks that may be different from or the same as the network over which the television program is received.

In yet another exemplary scenario, step 120 may comprise receiving the advertising content in real-time (when needed) during presentation of the programming content received at step 110. For example, step 120 may comprise receiving the advertising content for immediate real-time presentation of such received advertising content during a commercial break in the programming content presentation.

For example, in a scenario in which the communication network(s) over which advertising content is retrieved (e.g., at step 120) and the source(s) from which such advertising content is retrieved are highly reliable, advertising content may be retrieved for presentation in real-time (i.e., when needed for presentation).

In another exemplary scenario, step 120 may comprise receiving the advertising content before presentation of all of a program received at step 110. For example, in a scenario in which the network(s) and/or source(s) for advertising content are not highly reliable or where a safety margin is desired for network and/or source variability, step 120 may comprise retrieving/receiving advertising content before such content is needed for presentation. For example, step 120 may comprise retrieving/receiving the advertising content for an entire commercial break in the programming content prior to the commercial break occurring. For example, following a first commercial break, step 120 may comprise beginning to retrieve advertising content for a second commercial break in preparation for such second commercial break. Step 120 may, for example, comprise buffering such preemptively received advertising content in storage until needed. Step 120 may also, for example, comprise receiving and buffering advertising for a next plurality of commercial breaks, for a next particular amount of time (e.g., at least N minutes of advertising content), etc.

In still another exemplary scenario, step 120 may comprise receiving the advertising content before presentation of any of a program received at step 110. For example, in a scenario in which the communication network(s) over which advertising content is received and/or the source(s) from which such advertising content is received are relatively unreliable or where a large safety margin is desired, step 120 may comprise retrieving all advertising content for the program in response to selection of such program by the user or in anticipation of selection of such program by the user.

Also for example, step 120 may comprise retrieving the advertising content at the beginning of a program. For example, when a program is selected for play by a user, step 120 may begin retrieving all advertising content to be presented with such program. Also for example, before a program is selected for play, step 120 may comprise retrieving advertising content for at least an initial portion of the program (e.g., in anticipation of selection of the program by a user for presentation).

An advertising database may be maintained (e.g., at user equipment). For example, step 120 may comprise maintaining an advertising database at a television receiver implementing the method 100. For example, advertising content targeted for a particular user, user group, or household may be pre-stored at user equipment (e.g., a set top box with PVR capability). A programming provider may, for example, designate particular advertisements (or generally content from particular advertisers) to be downloaded to a particular receiver. The receiver at the household (e.g., implementing step 120) may then download the designated advertisements (e.g., via various networks different from the programming network) prior to an immediate need for presentation of such advertisements and store such downloaded advertising content. Note that stored advertising content may also be designated (or flagged) for particular users of a receiver.

Such locally stored advertising content may then be updated as needed (e.g., by tracking version numbers and/or dates associated with stored advertising content, etc.). In such a scenario in which received advertising content is stored locally, when a point of a program being presented is reached at which advertising content is to be presented, advertising content may be retrieved from the local advertising database for presentation to the user. After presentation of such advertising content, such advertising content may be removed from the advertising database or may be retained for repeated presentation.

In general, step 120 may comprise receiving advertising content from a second communication network (or a second one-or-more communication networks) different from the first communication network. Accordingly, the scope of various aspects of the present invention should not be limited by characteristics of any particular manner of performing such receiving unless explicitly claimed.

The exemplary method 100 may, for example at step 130, comprise integrating the received programming content and the received advertising content for presentation to a user. Such integrating may be performed in any of a variety of manners, non-limiting examples of which will now be presented.

For example, step 130 may comprise integrating the received programming content and the received advertising content prior to presentation of the received programming content. For example, step 130 may comprise managing memory pointers (e.g., at insertion points in a programming content file) to jump to and from an advertising content file at an advertisement insertion point in the programming content. In such a scenario, an entire data stream or data file for received programming content, including integrated received advertising content, can be prepared prior to presentation of the programming content.

Also for example, step 130 may comprise integrating the received programming content and the received advertising content during presentation of the received programming content. For example, during presentation of the received programming content, step 130 may comprise encountering a data marker (or flag) in the programming content designating that general or particular advertising content is to be inserted. Step 130 may then, for example, comprise presenting the advertising content and resuming presentation of the programming content when such advertising content presentation is complete.

Additionally for example, step 130 may comprise utilizing a timer-based approach for advertising content insertion. For example, as discussed previously, information regarding advertising content may be received, where such information identifies the timing of advertising content to be presented with programming content. In such a scenario, step 130 may comprise utilizing such timing information to determine when to present received advertising content and when to resume presentation of the programming content.

In general, step 130 may comprise integrating the received programming content and the received advertising content for presentation to a user. Accordingly, the scope of various aspects of the present invention should not be limited by characteristics of any particular manner of performing such integrating unless explicitly claimed.

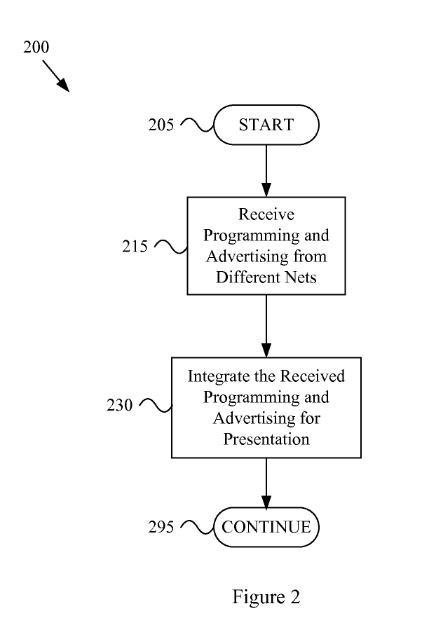

The exemplary method 100 may, for example at step 195, comprise performing continued operation. For example, step 195 may comprise directing execution flow of the exemplary method 100. For example, step 195 may comprise returning execution flow of the exemplary method 100 to any of the previous steps (e.g., for additional programming and/or advertising content receiving, and integrating). Also for example, step 195 may comprise performing any other operation discussed herein (e.g., with regard to any of the steps of the exemplary method 200 illustrated in FIG. 2 and discussed below).

Further for example, step 195 may comprise presenting received programming content and received advertising content to the user (e.g., on a television screen, on a personal computer screen, on a screen in parallel with a television screen, etc.). Such presentation may, for example, be performed on a video display housed with user equipment implementing the method 100, or may be performed by communicating programming and/or advertising information to another device for display (e.g., by outputting video display driver signals, video data signals, etc.).

Also for example, step 195 may comprise performing commercial transactions regarding the received advertising content. For example, step 195 may comprise communicating with commercial enterprises via the programming communication network (e.g., via which programming content was received at step 110) and/or the advertising communication network (e.g., via which advertising content was received at step 120) to perform such commercial transactions. Also for example, step 195 may comprise interacting with a user of user equipment implementing the method 100 regarding such commercial transaction. Such a commercial transaction may, for example, comprise ordering a consumer good and/or service advertised by the received advertising content (e.g., ordering an advertised consumer good via the Internet).

Additionally for example, step 195 may comprise communicating with a commercial enterprise via the advertising content network (e.g., via which advertising content was received at step 120) to order programming content to be delivered to the user via the programming network (e.g., via which the programming content was received at step 110). Such ordered programming may then, for example, be delivered via the programming network. Similarly, step 195 may comprise communicating with a commercial enterprise and/or a user to perform billing activities associated with such ordered programming content.

In general, step 195 may comprise performing continued operation. Accordingly, the scope of various aspects of the present invention should not be limited by characteristics of any particular type of continued operation unless explicitly claimed.

Note that although the above discussion generally concerned user equipment (e.g., a set top box, television receiver, PVR, etc.) performing the method 100, it should be noted that any or all of the steps of the method 100 may be performed by communication network infrastructure apparatus and/or content server apparatus. For example, the method 100 may also be performed by a distributed system comprising user equipment and one or more pieces of communication network infrastructure and/or content server apparatus. Accordingly, the scope of various aspects of the present invention should not be limited by characteristics of any particular implementing system unless explicitly claimed.

Turning next to FIG. 2, such figure shows a non-limiting exemplary flow diagram of a method 200 for communicating programming and advertising content, in accordance with various aspects of the present invention. The exemplary method 200 may, for example, share any or all characteristics with the exemplary method 100 illustrated in FIG. 1 and discussed previously. Any or all aspects of the exemplary method 200 may, for example, be implemented in user equipment (e.g., a user media presentation system, a personal video recorder, a television receiver (or set top box) with or without video recording capability, a gaming device with video recording capability, a personal computing device (e.g., handheld, notebook, laptop, desktop, etc.), etc.).

The exemplary method 200 may begin executing at step 205. Step 205 may, for example, share any or all characteristics with step 105 of the exemplary method 100 illustrated in FIG. 1 and discussed previously. Also for example, step 205 may begin executing at step 195 of the exemplary method 100 illustrated in FIG. 1.

The exemplary method 200 may, at step 215, comprise receiving programming content and advertising content from different respective communication networks. Step 215 may, for example, share any or all characteristics with steps 110 and 120 of the exemplary method 100 illustrated in FIG. 1 and discussed previously. For example and without limitation, step 215 may comprise receiving programming content from a programming content provider over a first communication network (e.g., a television network) and receiving advertising content from an advertising content provider over a second communication network (e.g., the Internet).

The exemplary method 200 may, at step 230, comprise integrating the received programming content and the received advertising content for presentation to a user. Step 230 may, for example, share any or all characteristics with step 130 of the exemplary method 100 illustrated in FIG. 1 and discussed previously.

The exemplary method 200 may, at step 295, comprise performing continued operation. Step 295 may, for example, share any or all characteristics with step 195 of the exemplary method 100 illustrated in FIG. 1 and discussed previously.

For example, step 295 may comprise directing execution flow of the exemplary method 200. For example, step 295 may comprise returning execution flow of the exemplary method 200 to any of the previous steps (e.g., for additional programming and/or advertising content receiving, and integrating). Also for example, step 295 may comprise performing any other operations discussed herein (e.g., with regard to any of the steps of the exemplary method 100 illustrated in FIG. 1 and discussed above).

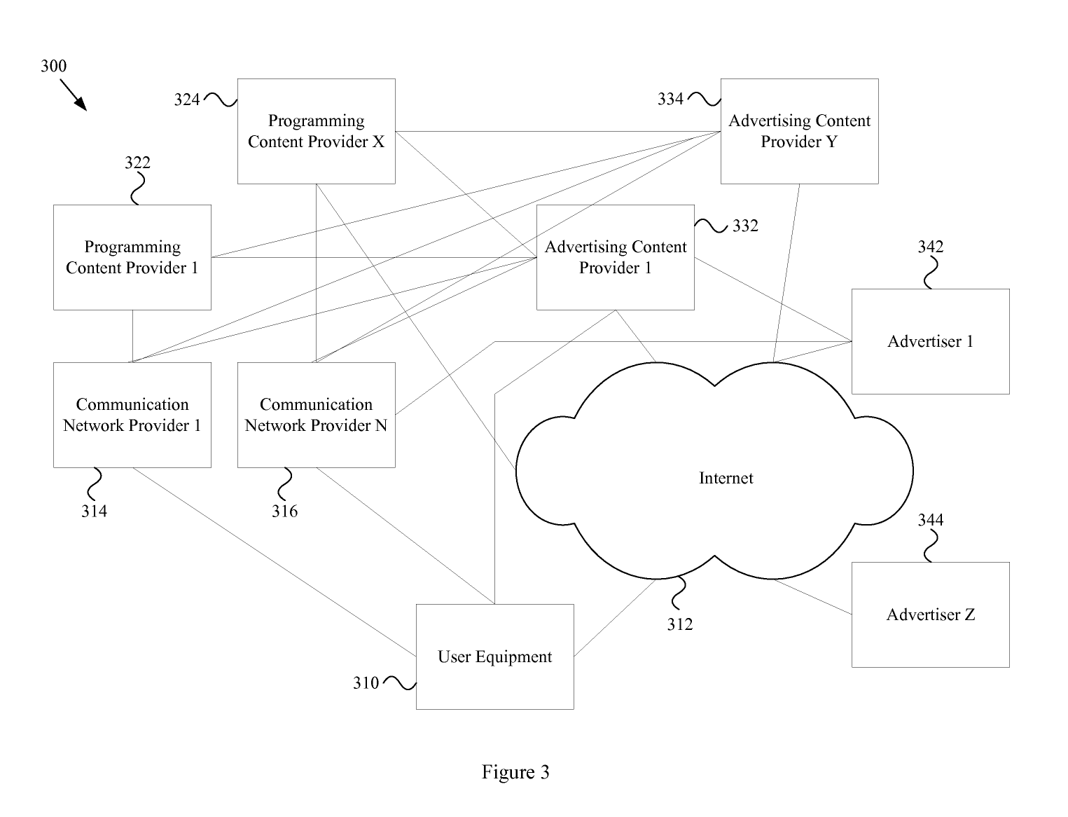

The previous discussions of FIGS. 1 and 2 included discussion of user equipment (e.g., a user's media presentation system) performing various aspects of the present invention. The previous discussion also mentioned that various aspects of the present invention may also be implemented in networked content source apparatus and/or communication network infrastructure apparatus. Such previous discussion also included general discussion of media content (e.g., audio/video programming and/or advertising content) sources. FIG. 3 is provided herein to provide a non-limiting example of a media content system including user equipment (e.g., a user's media presentation system), content providers, and communication networks communicatively coupling such entities. Such illustrative media content system is merely illustrative and non-limiting.

FIG. 3 is a diagram illustrating a media content (e.g., programming and/or advertising media content) distribution environment 300. The exemplary environment 300 comprises user equipment 310 (e.g., a user media presentation system, a personal video recorder, a television receiver (or set top box) with or without video recording capability, a gaming device, a personal computing device (e.g., handheld, notebook, laptop, desktop, etc.), etc.).

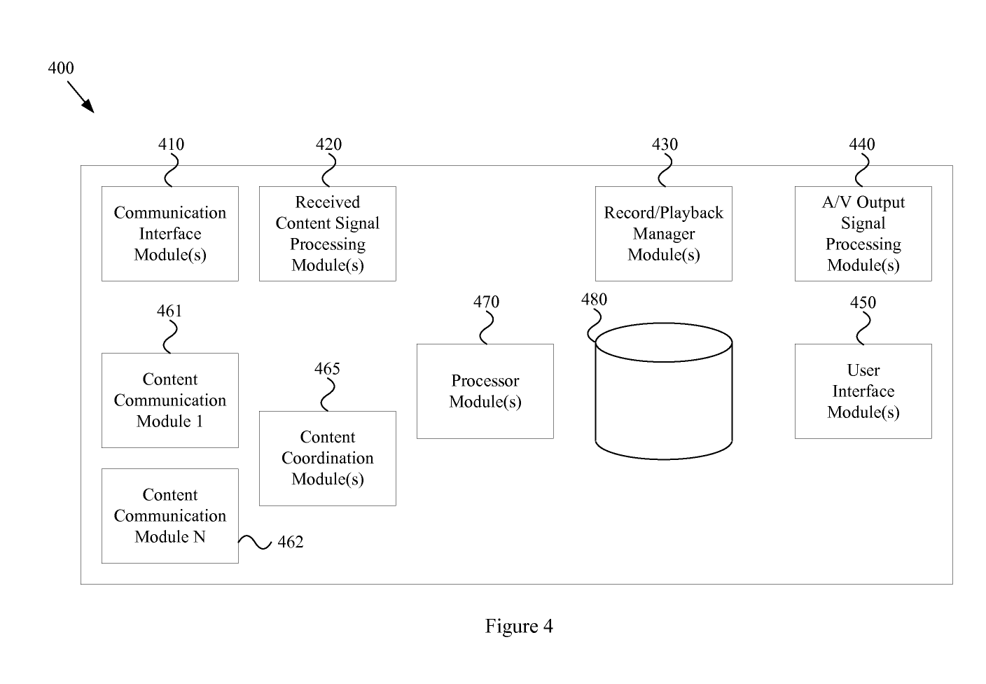

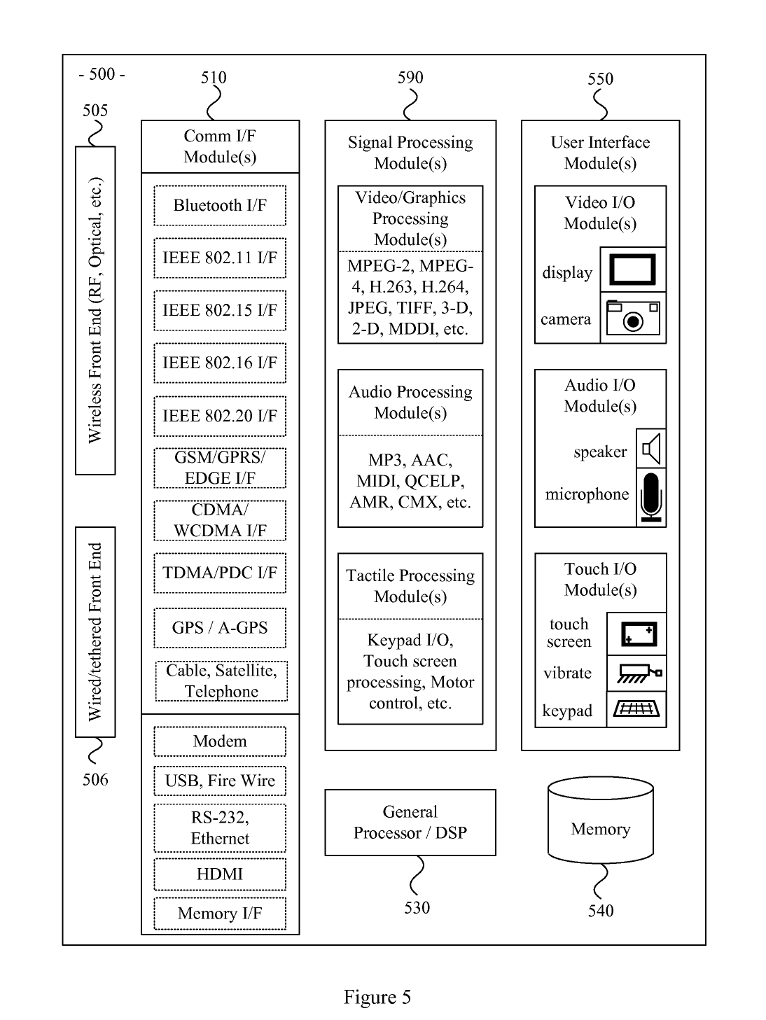

Such user equipment 310 may share any or all characteristics with the user equipment (e.g., a user's media presentation system) discussed elsewhere herein, including without limitation the user equipment 400 illustrated in FIG. 4 and the user equipment 500 illustrated in FIG. 5. The user equipment 310 may, for example, perform any or all of the functionality discussed previously with regard to the methods 100 and 200 illustrated in FIGS. 1-2 and discussed previously.

The exemplary environment 300 also comprises a plurality of communication networks (or communication network providers). For example, the user equipment 310 is communicatively coupled to a first communication network provider 314 and an N^{th} communication network provider 316. Such communication network providers (314 and 316) may operate to communicatively couple the user equipment 310 to any of a variety of different types of communication networks. For example, such communication network providers (314 and 316) may operate to provide the user equipment 310 access to cable and/or satellite television networks, wired and/or wireless telecommunication networks, wired and/or wireless data networks, wireless networks of various ranges (e.g., PANs, LANs, WANs, MANs, etc.), etc.

The exemplary environment 300 also comprises the Internet 312 (or Internet Service Provider). For example, the user equipment 310 may be communicatively coupled directly to the Internet 312 or via an Internet Service Provider. Note that the user equipment 310 may also, for example, be communicatively coupled to the Internet 312 via the first communication network provider 314 and/or N^{th} communication network provider 316.

The exemplary environment 300 also comprises a plurality of programming content providers (e.g., 1 to X programming providers). For example, the illustrated environment 300 shows a first programming content provider 322 and an X^{th} programming content provider 324. Such programming content providers (322 and 324) may operate to provide programming content (or any video content) to the user equipment 310 via any of the communication networks (or providers) discussed above. A programming provider may, for example, include a television programming provider, a computer network programming provider, a television network or portion thereof (e.g., Fox, NBC, CBS, ABC, ESPN, NFL, HGTV, etc.), etc.

In an exemplary scenario, the first programming content provider 314 may operate to communicate a first television program (or other media program) to the user equipment 310 via the first communication network provider 314. Such a first television program may, for example, comprise embedded first advertising video content that the first programming content provider 314 received from the first advertising content provider 332 and embedded into the first program.

In another exemplary scenario, the X^{th} programming content provider 314 may operate to communicate a second television program (or other media program) to the user equipment 310 via the N^{th} communication network provider 316 and/or via the Internet 312. Such second television program may, for example, alternatively contain no advertising content or contain advertising content received from any or all of the advertising content providers (332 or 334) or advertisers (342 or 344) in the environment 300 or external to the illustrated environment 300.

As mentioned previously, the user equipment 310 may interact with video content providers (e.g., programming content providers, advertising content providers, advertisers, communication service providers, etc.) to, at least in part, determine whether particular advertising content is available, to acquire advertising content, etc. In such an exemplary scenario, the user equipment 310 operates to communicate with any or all of the communication network providers (314 and 316), the programming content providers (322 and 324), the advertising content providers (332 and 334), and the advertisers (342 and 344).

As mentioned above, advertising video content may be embedded in programming video content. Also for example, as illustrated by various communication pathways in the environment 300, the user equipment 310 may operate to receive advertising content directly from the advertising content providers or advertisers (e.g., advertising enterprises).

As referred to above, the exemplary environment 300 also, for example, comprises a plurality of advertising content providers (e.g., 1 to Y advertising content providers). For example, the illustrated environment 300 shows a first advertising content provider 332 and a Y^{th} programming content provider 334. Such advertising content providers (332 and 334) may operate to provide advertising video content to the user equipment 310 via any of the communication networks (or providers) discussed above. Also for example, such advertising providers (332 and 334) may operate to provide advertising video content to the programming content providers (322 and 324) for ultimate communication to the user equipment 310 (e.g., embedded in a television program, communicated in a data stream independent of data streams communicating television programming, etc.).

Also, as mentioned above, the exemplary environment 300 also comprises a plurality of advertisers (e.g., 1 to Z advertisers). For example, the illustrated environment 300 shows a first advertiser 342 (e.g., a first commercial enterprise advertising a product or service provided by such first commercial enterprise) and a Z^{th} advertiser 344 (e.g., a Z^{th} commercial enterprise advertising a product or service provided by such Z^{th} commercial enterprise). As illustrated in FIG. 3, such advertisers (342 and 344) may operate to communicate advertising content (or related information) to enterprises that specialize in generating video advertising content (e.g., advertising content providers 332 and 334), communicate advertising content (or related information) to programming content providers (e.g., the programming content providers 322 and 324), communicate advertising content (or related information) to communication network providers (or networks) (e.g., the communication network providers 314 and 316, the Internet 312 (or ISP), etc.), and/or communicate advertising content (or related information) directly to the user equipment 310).

Note that any or all of the programming content providers, advertising content providers, and so on, may communicate information regarding advertising content. As mentioned previously, such information may be communicated with programming content, with electronic programming guide information, with general user information, etc.

In general, the exemplary environment 300 provides a non-limiting illustration of various entities that might or might not be present in any particular video content distribution system. Accordingly, the scope of various aspects of the present invention should not be limited by characteristics of the exemplary environment 300 unless explicitly claimed.

FIG. 4 is a diagram illustrating various non-limiting aspects of exemplary user equipment 400. The user equipment 400 may comprise characteristics of any of a variety of types of user equipment. For example and without limitation, the user equipment 400 may be or comprise an electronic device with video recording and playback capability. For example, the user equipment 400 may comprise a personal video recorder, a television receiver (or set top box, for example cable and/or satellite) with or without video recording capability, a gaming device, a television, a personal computing device (e.g., handheld, notebook, laptop, desktop, etc.), a distributed home network comprising communicatively coupled devices that operate to record and/or playback video content, etc. Such user equipment 400 may, for example, be integrated into a single housing or a plurality of housings of a personal media presentation system. In a configuration comprising a plurality of housings, such user equipment may be co-located or positioned at geographically distinct locations.

The user equipment 400 may, for example, share any or all characteristics with the user equipment 310 of the environment 300 illustrated in FIG. 3 and discussed previously. Also for example, the user equipment 400 (e.g., one or more modules thereof) may operate to (which includes “operate when enabled to”) perform any or all functionality discussed previously with regard to the methods 100 and 200 illustrated in FIGS. 1-2 and discussed previously.

The user equipment 400 may, for example, comprise one or more communication interface modules 410 that operate to perform any or all of the communication interface functionality discussed herein. The communication interface module(s) 410 may, for example, operate to communicate over any of a variety of communication media and utilizing any of a variety of communication protocols (e.g., including operating in accordance with various respective protocol layers, for example, PHY, MAC, network, transport, etc.). For example, the communication interface module 410 may be operable to communicate via one or more wired and/or wireless communication ports. The communication interface module(s) 410 may, for example, operate to communicate with one or more communication networks (e.g., cable television networks, satellite television networks, telecommunication networks, the Internet, local area networks, personal area networks, metropolitan area networks, satellite radio networks, legacy wireless television and/or radio networks, etc.) via which media content (e.g., television program content, advertising video content, audio program content, audio advertising content, etc.) and/or other data (e.g., information regarding advertising content, electronic programming guide information, user information, account information, commercial transaction data, general data, etc.) is communicated. Also for example, the communication interface module(s) 410 may operate to communicate with local sources of media content (e.g., video recorders, receivers, gaming devices, etc.) that may, for example, be external to but communicatively coupled to the user equipment 400. Additionally, for example, the communication interface module(s) 410 may operate to communicate with a controller for the user equipment (e.g., directly or via one or more intermediate communication networks).

The exemplary user equipment 400 may also comprise additional communication interface modules, which are not illustrated. Such additional communication interface modules may, for example, share any or all aspects with the communication interface module(s) 410 discussed above.

The exemplary user equipment 400 may comprise one or more signal processing modules 420. Such signal processing module(s) 420 may, for example, operate to process received media and/or data content (e.g., programming and/or advertising content, user interface content received via a communication network etc.). Such signal processing modules may, for example and without limitation, comprise video and/or audio decoding modules, transcoding modules that convert coded content from one code to another, audio processing modules, etc.

The exemplary user equipment 400 may comprise one or more media record/playback manager modules 430. Such module(s) 430 may operate to manage the recording and playback of video content (e.g., programming content, advertising content, etc.). Such module(s) 430 may operate to perform any or all of the media recording and/or playback functionality discussed herein.

Such module(s) 430 may, for example, operate to utilize the user interface module(s) 450 to interact with a user regarding desired recording and playback operation. Such module(s) 430 may, for example, operate to interact with the memory 480 (or with an external memory) for recording media content and/or reading recorded media content. Such module(s) 430 may, for example, operate to interact with the content coordination module(s) 465 which coordinates presentation of programming and advertising content to a user. Such module(s) 430 may also, for example, operate to utilize the A/V output signal processing module(s) 440 to process output audio and/or video content for ultimate presentation to a user.

As mentioned above, the exemplary user equipment 400 may also comprise one or more audio/video output signal processing modules 440. Such A/V output processing module(s) 440 may, for example, operate to process audio and/or video information for output to a display and/or speaker device. For example, such A/V output processing module(s) 440 may operate to receive stored video content information from the memory 480 and process such information (e.g., performing decoding, performing decompressing, converting video data into video display driver signals, etc.) for output to a user. For example, the A/V output processing module(s) 440 may operate to output audio speaker and/or video display driver signals. Also for example, the A/V output processing module(s) 440 may operate to output processed audio and/or video data for further downstream processing (e.g., for ultimate presentation to a user in human-perceivable form).

The exemplary user equipment 400 may also comprise one or more user interface modules 450. The user interface module(s) 450 may generally operate to provide user interface functionality to a user of the user equipment 400. The user interface module(s) 450 may, for example, operate to perform any or all of the user interface functionality discussed herein.

For example, and without limitation, the user interface module(s) 450 may operate to provide for user control of any or all standard user equipment commands (e.g., video recording and/or playback control, for example, record commands, playback commands scheduled recording commands, channel control, on/off control, video input and/or output selection, programming interaction, interacting with the user regarding the presentation of advertising video content before, during and/or after the presentation of the recorded program video content, etc.).

The user interface module(s) 450 may, for example, operate to respond to user commands utilizing user interface features disposed on the user equipment 400 (e.g., buttons, etc.) and may also utilize the communication module(s) 410 to communicate with a controller (e.g., a dedicated user equipment remote control, a universal remote control, a cellular telephone, personal computing device, gaming controller, etc.). Further for example, the user interface module(s) 450 may utilize the communication module(s) 410 to communicate with another device external to the user equipment 400 to utilize the user interface features of such external device.

The exemplary user equipment 400 may comprise one or more processors 470. The processor(s) 470 may, for example, comprise a general purpose processor, digital signal processor, application-specific processor, microcontroller, microprocessor, etc. For example, the processor(s) 470 may operate in accordance with software (or firmware) instructions. As mentioned previously, in addition to or in lieu of any or all functionality discussed herein being performed by discrete hardware (e.g., in distinct separate integrated circuits or combined into a single integrated circuit), any or all functionality discussed herein may be performed by a processor executing instructions. For example, though various modules are illustrated as separate blocks or modules in FIG. 4, such illustrative modules, or any portion thereof, may be implemented by the processor(s) 470.

The exemplary user equipment 400 may comprise one or more memories 480. As discussed above, any or all functional aspects discussed herein may be performed by one or more processors executing instructions. Such instructions may, for example, be stored in the one or more memories 480. Such memory 480 may, for example, comprise characteristics of any of a variety of types of memory. For example and without limitation, such memory 480 may comprise one or more memory chips (e.g., ROM, RAM, EPROM, EEPROM, flash memory, one-time-programmable OTP memory, etc.), hard drive memory, CD memory, DVD memory, etc.

Additionally, as discussed previously, the record/playback monitor module(s) 430 may interact with the memory 480 to store media content (e.g., programming content and/or advertising content) in the memory 480 and/or retrieve stored media content from the memory 480. In such a scenario, the memory 480 may comprise separate memories or may be partitioned to accommodate stored media content and processor instructions, along with user data and any other type of data (e.g., user profile information, user account information, scratch pad data, etc.).

The exemplary user equipment 400 may also comprise a first content communication module 461 (or plurality of first content communication modules). The first content communication module 461 may, for example, perform any or all media content communication functionality discussed herein. For example and without limitation, the first content communication module 461 may operate to perform any or all functionality with regard to step 110 of the exemplary method 100 illustrated in FIG. 1 and discussed previously and/or with regard to step 215 of the exemplary method 200 illustrated in FIG. 2 and discussed previously. For example, the first content communication module 461 may operate to receive programming content from a first communication network (or a first one-or-more communication networks). Various non-limiting examples of such operation will now be presented.

For example, the first content communication module 461 may operate to receive television programming (e.g., a television program) from a television network (e.g., a cable and/or satellite communication network, a legacy over-the-air television network, a data network with television content capability, an Internet television network, etc.). The module 461 may, for example, utilize the communication interface module(s) 410 to perform such communication, and may utilize the signal processing module(s) 420 to process such received programming content.

For example, the first content communication module 461 may operate to receive television programming via a single television network, or may comprise receiving television programming via a plurality of different television networks. Also for example, the first content communication module 461 may operate to receive television programming via a local or personal area network.

The first content communication module 461 may also, for example, operate to receive audio programming (e.g., an audio program) from a radio network (e.g., a satellite radio network, an Internet radio network, a legacy over-the-air radio network, etc.). For example, the module 461 may receive audio programming via a single audio (or radio) network, or may receive audio programming via a plurality of different audio networks. Also for example, the module 461 may receive audio programming via a local or personal area network. The module 461 may, for example, utilize the communication interface module(s) 410 to perform such communication, and may utilize the signal processing module(s) 420 to process such received programming content.

The first content communication module 461 may also receive information regarding advertising content (e.g., regarding advertising content that is to be presented with the received programming). For example, such information regarding advertising content may be received embedded in received media programming (e.g., in a data stream and/or file header or metadata, at a location in a programming data stream or file at which advertising content is to be inserted, at a location in a programming data stream or file that is prior to a commercial break (e.g., such that corresponding advertising content may be retrieved in time for utilization in an upcoming commercial break), etc.).

Also for example, such information regarding advertising content may be received with program guide information. For example, such information regarding advertising content may be received in a data stream that communicates channel, time and date information for television programs. For example, information for a particular television program may comprise information regarding advertising content that corresponds to the particular television program (e.g., regarding advertising content that is to be presented during presentation of the particular television program).

Further for example, such information regarding advertising content may be received in a data stream (or data file) independent of television programming information and electronic guide information. For example, such information regarding advertising content may be received during periodic advertising update communications, during user account information communication, etc.

Note that the first content communication module 461 may operate to receive such information regarding advertising content for programming from any of a variety of communication networks. For example, the first content communication module 461 may operate to receive such information from the same communication network(s) over which media programming content is received. For example, the first content communication module 461 may receive such information and receive television programming content via a same television network. Also for example, the first content communication module 461 may receive such information from one or more communication networks different from the communication network(s) over which media programming content is received. For example, the first content communication module 461 may receive such information over a general data network or telecommunication network and receive media programming content via a television network.

Such information regarding advertising content may comprise any of a variety of characteristics, non-limiting examples of which will now be provided. For example, the information regarding advertising content received by the first content communication module 461 may, for example, comprise information describing the relationship between programming content and advertising content (e.g., information describing the overall presentation of media content comprising both programming content and advertising content). Such relationship may, for example, comprise information describing a temporal relationship between programming content and advertising content. For example, such information may comprise information identifying a time in programming content at which advertising content should start, a time window in programming content during which advertising content should be inserted and presented, etc. Such time (or timing) information may, for example, comprise information regarding required exact timing and/or recommended (or target) timing. The content coordination module(s) 465, which will be discussed in more detail later, may utilize such timing information to coordinate the presentation of programming content and advertising content to a user.

Such time information may, for example, comprise a plurality of timing options. Such timing options may, for example, be selected based on whether and/or how much advertising is to be presented. For example, different respective users and/or user equipment 400 may correspond to different respective amounts of advertising to be presented. For example, different users may pay for different respective levels of service, where such different levels of service may correspond to different respective amounts of advertising content. Some of such levels of service may, for example, correspond to the presentation of no advertising content. Also for example, a timing option may be selected based on the availability of advertising. For example, in a scenario in which advertising content that is ideally to be presented during a particular time window is unavailable, a shorter-than-normal time window may be selected from the plurality of timing options, and a longer-than-normal time window may be selected for a subsequent advertising content time window to compensate for the currently selected short-than-normal time window. The content coordination module(s) 465, which will be discussed in more detail later, may utilize such timing information to select a particular timing scheme to utilize for integrating received programming content and received advertising content.

Such time information may, for example, comprise information identifying timing constraints on an advertising window that may be flexibly filled by the user equipment 400 (e.g., the content coordination module(s) 465). For example, in an exemplary scenario, such timing information might indicate that at time A+/−2 minutes, the user equipment 400 (or other system) will stop presentation of a media program and present B minutes+/−15 seconds of advertising before resuming presentation of the media program. Such flexibility may, for example, be utilized advantageously in systems providing targeted advertising of a wide variety of different respective advertising content to different respective users. Note that such operation may also comprise buffering programming content to compensate when inserted advertising content is larger than an allocated time window, and playing buffered programming content to fill-in when inserted advertising content is smaller than an allocated time window. Such buffering may, for example, be performed by the content coordination module(s) 465 (e.g., working in conjunction with the memory 480 and/or the record/playback manager module(s) 430).

The information regarding advertising content may also, for example, comprise information identifying particular advertising content. For example, such information may comprise information of a title of an advertisement (or title of an advertising content data file). Also for example, such information may comprise information of a version number (or date) for an advertisement. In such a scenario, the user equipment 400, which may have advertising content stored on-board (e.g., in the memory 480) or on a local networked storage device (e.g., accessible via the communication interface module(s) 410), may determine whether such locally stored advertising content should be updated. Additionally for example, such information may comprise information of a memory system path to a stored advertising content file (e.g., listing disc drive, file directory structure, and file name). In an exemplary scenario, the information regarding advertising content may be inserted in a media program such that when such information is encountered, such encounter will trigger retrieval, receiving, and insertion of the specifically-identified advertising content. For example, as will be discussed later, the content coordination module(s) 465 may operate to utilize a content communication module to receive and/or retrieve advertising content, and may then coordinate the insertion of such received advertising content in received programming content.

The information regarding advertising content may, for example, comprise information identifying one or more sources for identified advertising content. Such source information may, for example, comprise information identifying a particular advertiser, a communication network source, a centralized advertising content database, a content provider's server, etc.

In an exemplary scenario, such source information may comprise information identifying a communication network address of the source of the advertising content. Such a communication network address may, for example, comprise a Uniform Resource Locator (URL) associated with advertising content. Such a communication network address may, for example, comprise an Internet address, local area network address, personal area network address, telecommunication network address, television network address, etc. Such source information may, for example, comprise information of a communication network address and a directly path for a file at such address.

Such source information may, for example comprise information identifying a programming source, an advertising agency, a commercial enterprise associated with a particular advertised good and/or service, etc. As mentioned above, such source information may comprise information identifying one or more communication network addresses associated with such entities (or with networked equipment associated with such entities).

In an exemplary scenario, such source information may identify a plurality of different communication network addresses associated with a plurality of different respective advertisements, where such network addresses may be on a same network (e.g., a programming network, the Internet, etc.) or such network addresses may be on different respective networks (e.g., a first network address for advertising content on a programming network, a second network address for advertising content on the Internet, a third network address for advertising content on a telecommunication network, a fourth network address for an advertisement on a local area network, etc.). For example, in an exemplary scenario, the content coordination module(s) 465 may operate to utilize a content communication module to receive and/or retrieve advertising content from one or more identified sources of the desired advertising content, and may then coordinate the insertion of such received advertising content in received programming content.

Advertising content may, for example, be consistent between all presentations of a program, or such content may be targeted to particular users and/or households. For example, information regarding advertising content may comprise a list of advertisements that must be presented, should be presented, and/or may be presented during a program. Such a list may, for example, be universal or customized for a user, a group of users, a home media presentation system (or other user equipment), a household, etc. The content coordination module(s) 465 may, for example, process such information to determine which advertising content and/or how much advertising content to present.

Also for example, such information regarding advertising content may comprise information identifying alternative advertising content that may be presented during presentation of a program. For example, in such a scenario, the content coordination module(s) 465 may select from between a plurality of advertising content options for presentation during programming content presentation.

In general, the first content communication module 461 may operate to receive content (e.g., programming content) from a first communication network. Accordingly, the scope of various aspects of the present invention should not be limited by characteristics of any particular manner of receiving programming content and/or by characteristics of receiving information in addition to programming content (e.g., information regarding advertising content) unless explicitly claimed.

Although the previous discussion generally concerned the communication of programming content and the first content communication module 461 may be dedicated to the communication of programming content (or programming content with embedded advertising content), the first content communication module 461 may also be operable to communicate advertising content (e.g., via one or more communication networks that are the same as the communication network(s) via which programming content is communicated, or via one or more communication networks different from the communication network(s) via which programming content is communicated).

The exemplary user equipment 400 may comprise a plurality of content communication modules, one of which is illustrated as the N^{th} content communication module 462 (or plurality of N^{th} content communication modules), where N is an integer greater than one. For example, the exemplary user equipment 400 may comprise a second content communication module, a third content communication module, etc.

The N^{th} content communication module 462, may, for example, perform any or all content communication functionality discussed herein. For example and without limitation, the N^{th} content communication module 462 may operate to perform any or all functionality with regard to step 120 of the exemplary method 100 illustrated in FIG. 1 and discussed previously and/or with regard to step 215 of the exemplary method 200 illustrated in FIG. 2 and discussed previously. For example, the N^{th} content communication module 462 may operate to receive programming content from a second (or N^{th}) communication network (or a second one-or-more communication networks). Various non-limiting examples of such operation will now be presented.

As discussed above, advertising content may be identified as being provided over various networks, which may or may not be the same as the network(s) over which programming content is provided. For example, the N^{th} content communication module 462 may utilize the communication interface module(s) 410 to receive the advertising content from a second communication network that is different from the first communication network via which programming content is received (e.g., by the first content communication module 461), and may also operate to receive advertising content from the first communication network. In such a scenario, advertising content that is ultimately presented to the user may be received from a plurality of different communication networks (e.g., received by both the first content communication module 461 and the N^{th} content communication module 462). Note that such different communication networks may share common components (e.g., a portion of cable television infrastructure may carry both television network programming traffic and Internet data traffic). Alternatively for example, such different communication networks may be completely independent of each other. Note that even in an exemplary scenario in which advertising content is received over a communication network different from the communication network via which programming content is received (e.g., by the first content communication module 461), such advertising content and programming content may be received from a same source or from different respective sources.

The N^{th} content communication module 462 may, for example, operate to receive advertising content in a passive and/or active manner. For example, the N^{th} content communication module 462 may operate to utilize the communication interface module(s) 410 to passively receive advertising content that is broadcast and/or advertising content that is addressed to equipment (e.g., the user equipment 400), for example addressed by unicasting, multicasting, etc. Such advertising content may, for example, be received without requesting such content.

Also for example, the N^{th} content communication module 462 may operate to utilize the communication interface module(s) 410 to actively retrieving advertising content (e.g., by request or solicitation) from a source of such content. As discussed above, information regarding advertising content may be received, where such information identifies advertising content and/or a source of such advertising content. In such an exemplary scenario, the N^{th} content communication module 462 may operate to utilize the communication interface module(s) 410 to communicate a message to such an advertising content source to request the identified advertising content from such source, and then receive the requested advertising content from such source.

In a non-limiting exemplary scenario, programming content and programming guide information may be received from a cable television network. As discussed above, such programming guide information may identify the source of a program, advertising content to be presented during such a program, and sources of such advertising content. Before or during presentation of a selected program, the N^{th} content communication module 462 may operate to retrieve the identified advertising content associated with a selected program. For example, during presentation of a movie, the N^{th} content communication module 462 may utilize the communication interface module(s) 410 to concurrently communicate with an advertising agency or advertiser over the Internet, while the first content communication module 461 is receiving programming content, to obtain advertising content for presentation during the program being received by the first content communication module 461 (e.g., at the next commercial break). That is, the programming content receiving and the advertising content receiving may be performed concurrently by the first content communication module 461 and the N^{th} content communication module 462 (e.g., simultaneously and/or pseudo-simultaneously in a time-multiplexed manner). In such an exemplary scenario, at a designated point in the program (e.g., as flagged by the programmer), the retrieved advertising content may be presented (e.g., such presentation being coordinated by the content coordination module(s) 465).

In another exemplary scenario, information identifying advertising content may be received with the programming content received by the first content communication module 461 (e.g., embedded in the program video/audio data, included in a file or data stream header, included as metadata, etc.). The N^{th} content communication module 462 may then operate to retrieve/receive the identified advertising content.

In yet another exemplary scenario, the user equipment 400 may receive and play a television program. During presentation of the television program, the user equipment 400 (e.g., the content coordination module(s) 465) identifies advertising content, advertising content presentation timing, and the source of such advertising content. Then, during such presentation of the television program, the user equipment 400 (e.g., the N^{th} content communication module 462) retrieves the advertising content over one or more various networks that may be different from or the same as the network over which the television program is received.

In yet another exemplary scenario, the N^{th} content communication module 462 may operate to receive the advertising content in real-time (when needed) during presentation of the programming content received by the first content communication module 461. For example, the N^{th} content communication module 462 may operate to receive the advertising content for immediate real-time presentation of such received advertising content during a commercial break in the programming content presentation. The content coordination module(s) 465 may, for example, coordinate such reception and presentation.

For example, in a scenario in which the communication network(s) over which advertising content is retrieved (e.g., by the N^{th} content communication module 462) and the source(s) from which such advertising content is retrieved are highly reliable, advertising content may be retrieved for presentation in real-time (i.e., when needed for presentation).

In another exemplary scenario, the N^{th} content communication module 462 may operate to receive the advertising content before presentation of all of the program received by the first content communication module 461. For example, in a scenario in which the network(s) and/or source(s) for advertising content are not highly reliable or where a safety margin is desired for network and/or source variability, the N^{th} content communication module 462 may operate to retrieve/receive advertising content before such content is needed for presentation. For example, the N^{th} content communication module 462 may operate to retrieve/receive the advertising content for an entire commercial break in the programming content prior to the commercial break occurring. For example, following a first commercial break, the N^{th} content communication module 462 may begin to retrieve advertising content for a second commercial break in preparation for such second commercial break. For example, the content coordination module(s) 465 may operate to coordinate such content retrieving activity. The user equipment 400 (e.g., the content coordination module(s) 465 in conjunction with the record/playback manager module(s) 430) may, for example, comprise buffering such preemptively received advertising content in storage (e.g., in the memory 480) until needed. The user equipment 400 may also, for example, operate to receive and buffer advertising for a next plurality of commercial breaks, for a next particular amount of time (e.g., at least N minutes of advertising content), etc.

In still another exemplary scenario, the N^{th} content communication module 462 may operate to receive the advertising content before presentation of any the program received by the first content communication module 461. For example, in a scenario in which the communication network(s) over which advertising content is received and/or the source(s) from which such advertising content is received are relatively unreliable or where a large safety margin is desired, the N^{th} content communication module 462 may retrieve all advertising content for the program in response to selection of such program by the user or in anticipation of selection of such program by the user. Again, such activity may be coordinated by the content coordination module(s) 465.

Also for example, the N^{th} content communication module 462 may operate to retrieve the advertising content at the beginning of a program. For example, when a program is selected for play by a user, the N^{th} content communication module 462 may begin retrieving all advertising content to be presented with such program. Also for example, before a program is selected for play, the N^{th} content communication module 462 may retrieve advertising content for at least an initial portion of the program (e.g., in anticipation of selection of the program by a user for presentation).

An advertising database may be maintained (e.g., at the user equipment 400). For example, the content coordination module(s) 465 may operate to maintain an advertising database at the user equipment 400 (e.g., stored in the memory 480). For example, advertising content targeted for a particular user, user group, or household may be pre-stored at the user equipment 400 (e.g., a set top box with PVR capability). A programming provider may, for example, designate particular advertisements (or generally content from particular advertisers) to be downloaded to particular user equipment. The user equipment 400 at the household (e.g., the N^{th} content communication module 462 and the content coordination module(s) 465) may then download the designated advertisements (e.g., via various networks different from the programming network) prior to an immediate need for presentation of such advertisements and store such downloaded advertising content (e.g., in the memory 480). Note that stored advertising content may also be designated (or flagged) for particular users of the user equipment 400.

Such locally stored advertising content may then be updated as needed by the user equipment 400 (e.g., by tracking version numbers and/or dates associated with stored advertising content, etc.). In such a scenario in which received advertising content is stored locally, when a point of a program being presented is reached at which advertising content is to be presented, advertising content may be retrieved from the local advertising database for presentation to the user. After presentation of such advertising content, such advertising content may be removed from the advertising database or may be retained for repeated presentation. The content coordination module(s) 465 may, for example, operate to coordinate such activity.

In general, the N^{th} content communication module 462 may operate to receive content (e.g., advertising content) from an N^{th} (e.g., a second, third, etc.) communication network, where such communication network may be different from the communication network via which the first content communication module 461 receives content (e.g., programming content). Accordingly, the scope of various aspects of the present invention should not be limited by characteristics of any particular manner of receiving advertising content and/or by characteristics of receiving information in addition to advertising content (e.g., information regarding advertising content) unless explicitly claimed.

Although the previous discussion generally concerned the communication of advertising content and the N^{th} content communication module 462 may be dedicated to the communication of advertising content (or programming content with embedded advertising content), the N^{th} content communication module 462 may also be operable to communicate programming content (e.g., via one or more communication networks that are the same as the communication network(s) via which content is received by the first content communication module 461, or via one or more communication networks different from the communication network(s) via which content is received by the first content communication module 461).

The exemplary user equipment 400 may comprise a content coordination module 465 (or a plurality of modules). Such a content coordination module 465 may, for example as discussed above, operate to coordinate the reception of programming and/or advertising content, the storage of such content (if necessary) and the presentation of such content. For example and without limitation, the content coordination module 465 may operate to perform any or all of the content coordination functionality discussed herein. For example, the content coordination module 465 may operate to perform any or all functionality with regard to step 130 of the exemplary method 100 illustrated in FIG. 1 and discussed previously and/or with regard to step 230 of the exemplary method 200 illustrated in FIG. 2 and discussed previously. For example, the content coordination module 465 may operate to integrate received programming content (e.g., as received by the first content communication module 461) and received advertising content (e.g., as received by the N^{th} content communication module 462) for presentation to a user. Various non-limiting examples of such operation will now be presented.

For example, the content coordination module 465 may operate to integrate the received programming content and the received advertising content prior to presentation of the received programming content (e.g., by the user equipment 400). For example, the content coordination module 465 may operate to manage memory pointers (e.g., at insertion points in a programming content file) to jump to and from an advertising content file at an advertisement insertion point in the programming content. In such a scenario, an entire data stream or file for received programming content, including integrated received advertising content, can be prepared prior to presentation of the programming content.

Also for example, the content coordination module 465 may operate to integrate the received programming content and the received advertising content during presentation of the received programming content. For example, during presentation of the received programming content, the content coordination module 465 may monitor the data of such programming content for a data marker (or flag) in the programming content designating that general or particular advertising content is to be inserted. The content coordination module 465 may then, for example, operate to present the advertising content and resume presentation of the programming content when such advertising content presentation is complete.

Additionally for example, the content coordination module 465 may operate to utilize a timer-based approach for advertising content insertion. For example, as discussed previously, information regarding advertising content may be received, where such information identifies the timing of advertising content to be presented with programming content. In such a scenario, the content coordination module 465 may process such timing information to determine when to present received advertising content and when to resume presentation of the programming content.

In general, the content coordination module 465 may operate to perform any of the functionality discussed herein with regard to coordination of content reception, storage and reading, and presentation. Accordingly, the scope of various aspects of the present invention should not be limited by characteristics of any particular manner of performing such activities unless explicitly claimed.

The user equipment 400 (e.g., the processor module(s) 470) may operate to perform any of a variety of additional functionality, various examples of which have been discussed herein. For example and without limitation, the user equipment 400 (e.g., the processor module(s) 470) may operate to perform any of the continued functionality discussed previously with regard to step 195 of the exemplary method 100 and step 295 of the exemplary method 200.

For example, the user equipment 400 (e.g., the record/playback manager module(s) 430 and the A/V output signal processing module(s) 440) may operate to present received programming content and received advertising content to the user (e.g., on a television screen, on a personal computer screen, on a screen in parallel with a television screen, etc.). Such presentation may, for example, be performed on a video display housed with the user equipment 400, or may be performed by communicating programming and/or advertising information to another device for display.

Also for example, the user equipment 400 (e.g., the processor(s) 470 and communication interface module(s) 410) may operate to perform commercial transactions regarding the received advertising content. For example, the user equipment 400 may operate to communicate with commercial enterprises via the programming communication network (e.g., via which programming content is received by the first content communication module 461) and/or the advertising communication network (e.g., via which advertising content was received by the N^{th} content communication module 462) to perform such commercial transactions. Also for example, the user equipment 400 may operate to interact with a user of the user equipment 400 (e.g., utilizing the user interface module(s) 450) regarding such commercial transaction. Such a commercial transaction may, for example, comprise ordering a consumer good and/or service advertised by the received advertising content (e.g., ordering an advertised consumer good via the Internet).

Additionally for example, the user equipment 400 may operate to communicate with a commercial enterprise via the advertising content network (e.g., via which advertising content is received by the N^{th} content communication module 462) to order programming content to be delivered to the user via the programming network (e.g., via which programming content is received by the first content communication module 461). Such ordered programming may then, for example, be delivered via the programming network. Similarly, the user equipment 400 may operate to utilize the communication interface module(s) 410 to communicate with a commercial enterprise and/or a user to perform billing activities associated with such ordered programming content.

Turning next to FIG. 5, such figure is a diagram illustrating exemplary modules and/or sub-modules for user equipment 500, in accordance with various aspects of the present invention. The exemplary user equipment 500 may share any or all aspects with any of the user equipment 310 and 400 discussed herein and illustrated in FIGS. 3 and 4. For example, the exemplary user equipment 500 (or various modules thereof) may operate to perform any or all functionality discussed herein with regard to the exemplary method 100 illustrated in FIG. 1 and/or the exemplary method 200 illustrated in FIG. 2. As with the exemplary user equipment 400, the components of the exemplary user equipment 500 may be disposed in a single user device (e.g., a set top box, a personal video recorder, a television receiver, a gaming device with, a personal computing device, etc.).

For example, the user equipment 500 comprises a processor 530. Such a processor 530 may, for example, share any or all characteristics with the processor(s) 470 discussed with regard to FIG. 4. Also for example, the user equipment 500 comprises a memory 540. Such memory 540 may, for example, share any or all characteristics with the memory 480 discussed with regard to FIG. 4.

Also for example, the user equipment 500 may comprise any of a variety of user interface module(s) 550. Such user interface module(s) 550 may, for example, share any or all characteristics with the user interface module(s) 450 discussed previously with regard to FIG. 4. For example and without limitation, the user interface module(s) 550 may comprise: a display device, a camera (for still or moving picture acquisition), a speaker, an earphone (e.g., wired or wireless), a microphone, a video screen (e.g., a touch screen), a vibrating mechanism, a keypad, and/or any of a variety of other user interface devices (e.g., a mouse, a trackball, a touch pad, touch screen, light pen, game controlling device, etc.).

The exemplary user equipment 500 may also, for example, comprise any of a variety of communication modules (505, 506, and 510). Such communication module(s) may, for example, share any or all characteristics with the communication interface module(s) 410 discussed previously with regard to FIG. 4. For example and without limitation, the communication interface module(s) 510 may comprise: a Bluetooth interface module; an IEEE 802.11, 802.15, 802.16 and/or 802.20 module; any of a variety of cellular telecommunication interface modules (e.g., GSM/GPRS/EDGE, CDMA/CDMA2000/1x-EV-DO, WCDMA/HSDPA/HSUPA, TDMA/PDC, WiMAX, etc.); any of a variety of position-related communication interface modules (e.g., GPS, A-GPS, etc.); any of a variety of wired/tethered communication interface modules (e.g., USB, Fire Wire, RS-232, HDMI, Ethernet, television cable, wire line and/or cable modem, etc.); any of a variety of communication interface modules related to communicating with external memory devices; etc. The exemplary user equipment 500 is also illustrated as comprising various wired 506 and/or wireless 505 front-end modules that may, for example, be included in the communication interface modules and/or utilized thereby.

The exemplary user equipment 500 may also comprise any of a variety of signal processing module(s) 590. Such signal processing module(s) 590 may share any or all characteristics with modules of the exemplary user equipment 400 that perform signal processing. Such signal processing module(s) 590 may, for example, be utilized to assist in processing various types of information discussed previously (e.g., with regard to sensor processing, position determination, video processing, image processing, audio processing, general user interface information data processing, etc.). For example and without limitation, the signal processing module(s) 590 may comprise: video/graphics processing modules (e.g. MPEG-2, MPEG-4, H.263, H.264, JPEG, TIFF, 3-D, 2-D, MDDI, etc.); audio processing modules (e.g., MP3, AAC, MIDI, QCELP, AMR, CMX, etc.); and/or tactile processing modules (e.g., keypad I/O, touch screen processing, motor control, etc.).

In summary, various aspects of the present invention provide a system and method for communicating programming and advertising content through diverse communication networks, substantially as shown in and/or described in connection with at least one of the figures, as set forth more completely in the claims. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for communicating media content through diverse communication networks, the method comprising:
in user equipment:
receiving programming content from a first communication network;
receiving advertising content from a second communication network different from the first communication network; and
integrating the received programming content and the received advertising content for presentation to a user.

2. The method of claim 1, wherein said receiving programming content and said receiving advertising content are performed concurrently.

3. The method of claim 1, comprising, in the user equipment, receiving second advertising content from the first communication network.

4. The method of claim 1, comprising, in the user equipment, receiving from the first communication network information regarding receiving the advertising content from the second communication network.

5. The method of claim 4, wherein the information regarding receiving the advertising content is communicated with the programming content.

6. The method of claim 4, wherein the information regarding receiving the advertising content comprises information identifying the advertising content.

7. The method of claim 4, wherein the information regarding receiving the advertising content comprises timing information.

8. The method of claim 4, wherein the information regarding receiving the advertising content comprises information identifying a source of the advertising content.

9. The method of claim 8, wherein the information identifying a source of the advertising content comprises information identifying a communication network address of the source of the advertising content.

10. The method of claim 4, wherein the information regarding receiving the advertising content is communicated with electronic program guide information.

11. The method of claim 1, wherein said receiving advertising content from a second communication network comprises soliciting the advertising content from a source of advertising content.

12. The method of claim 1, wherein said receiving advertising content comprises receiving the advertising content before presentation of the programming content.

13. The method of claim 1, wherein said receiving advertising content comprises receiving the advertising content during presentation of the programming content.

14. The method of claim 13, wherein said receiving advertising content comprises receiving the advertising content for immediate real-time presentation during a commercial break in the programming content presentation.

15. The method of claim 13, wherein said receiving advertising content comprises receiving the advertising content for an entire commercial break in the programming content prior to the commercial break occurring.

16. The method of claim 13, wherein said integrating comprises inserting the received advertising content in the received programming content at an insertion point of the received programming content that is flagged in the received programming content.

17. A system in user equipment for communicating media content through diverse communication networks, the system comprising:
at least one module operable to, at least:
receive programming content from a first communication network;
receive advertising content from a second communication network different from the first communication network; and
integrate the received programming content and the received advertising content for presentation to a user.

18. The system of claim 17, wherein said at least one module is operable to receive the programming content and receive the advertising content concurrently.

19. The system of claim 17, wherein said at least one module is operable to receive second advertising content from the first communication network.

20. The system of claim 17, wherein said at least one module is operable to receive from the first communication network information regarding receiving the advertising content from the second communication network.

21. The system of claim 20, wherein the information regarding receiving the advertising content is communicated with the programming content.

22. The system of claim 20, wherein the information regarding receiving the advertising content comprises information identifying the advertising content.

23. The system of claim 20, wherein the information regarding receiving the advertising content comprises timing information.

24. The system of claim 20, wherein the information regarding receiving the advertising content comprises information identifying a source of the advertising content.

25. The system of claim 24, wherein the information identifying a source of the advertising content comprises information identifying a communication network address of the source of the advertising content.

26. The system of claim 20, wherein the information regarding receiving the advertising content is communicated with electronic program guide information.

27. The system of claim 17, wherein said at least one module is operable to receive the advertising content from the second communication network by, at least in part, operating to solicit the advertising content from a source of advertising content.

28. The system of claim 17, wherein said at least one module is operable to receive the advertising content from the second communication network by, at least in part, operating to receive the advertising content before presentation of the programming content.

29. The system of claim 17, wherein said at least one module is operable to receive the advertising content from the second communication network by, at least in part, operating to receive the advertising content during presentation of the programming content.

30. The system of claim 29, wherein said at least one module is operable to receive the advertising content from the second communication network by, at least in part, operating to receive the advertising content for immediate real-time presentation during a commercial break in the programming content presentation.

31. The system of claim 29, wherein said at least one module is operable to receive the advertising content from the second communication network by, at least in part, operating to receive the advertising content for an entire commercial break in the programming content prior to the commercial break occurring.

32. The system of claim 29, wherein said at least one module is operable to integrate the received programming content and the received advertising content by, at least in part, operating to insert the received advertising content in the received programming content at an insertion point of the received programming content that is flagged in the received programming content.
